(19) United States
(12) Patent Application Publication
(10) Pub. No.: US 2007/0171577 A1
(43) Pub. Date: Jul. 26, 2007

(54) Tape drive actuator using a four-bar flexure and planar coil system

(75) Inventor: John A. Ycas, Boulder, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/336,020

(22) Filed: Jan. 20, 2006

(51) Int. Cl. G11B 5/55

(52) U.S. Cl. 360/261.1

(57) ABSTRACT

A high-frequency tape head actuator has a positioning coil mounted close to a tape read/write head and between two thin flexures, which are flexible in a plane of flexion but stiff in other planes. One end of each flexure is attached to a fine positioner that holds the coil and the tape head. The other end of each flexure is attached to a base, such as a coarse positioner, which moves in the plane of flexion transversely to the length of a magnetic tape to read and write data on the tape. The base includes a magnet, which produces a magnetic field to precisely move the fine positioner in the plane of flexion. The position of the coil close to the center of mass of the fine positioner allows the fine positioner to operate at high frequencies, thereby allowing increased tracking precision and greater data storage capacities.

### BACKGROUND

1. Field of the Invention

The invention relates generally to magnetic tape systems, and more particularly, to a tape-head actuator.

2. Description of the Related Art

In the data storage industry, data is stored on magnetic tapes in multiple parallel, longitudinal tracks. Tape drives write data to and read data from these tapes using a read/write head. The read/write head can have a number of data read/write elements to access multiple tracks simultaneously, but the number of tracks is generally greater than the number of read/write elements that can be fabricated on a read/write head, so an actuator in the tape drive moves the head transversely across the tape surface to read or write data on the tracks as the tape moves past the head in a longitudinal direction. The actuator precisely positions the tape head. More specifically, as the tape moves relative to the head, the actuator rapidly moves the head to precise locations in response to control signals and servo signals recorded on special tracks on the tape.

The actuator has its first or fundamental resonance designed to be as low as possible, commonly below 250 Hz. In order to achieve the best tracking capability the next, i.e., higher order, resonance(s), sometimes referred to herein as resonant frequencies, should be as high as possible so that the servo control system can accurately follow the tracks and reject disturbances in the tape motion. The resonances and the mode shapes, i.e., the three dimensional motion of the actuator at these resonant frequencies, depend on the shape and structure of the actuator. These higher order resonances limit the ability of the tracking system to keep the head centered on the tracks to be written or read. Therefore, the higher order resonances limit how small the tracks can be. Since the track size directly affects the data storage capacity of the tape, the resonances are a critical factor affecting tape storage capacity. Increasing the frequency of the resonances to well above the servo control system bandwidth allows the tracks to be smaller and therefore allows storage capacity to be increased.

Existing actuators are limited to a servo frequency of around 500 Hz because of resonant frequencies in the mechanics of the actuators. Since the actuator's resonant frequencies limit the amount of lateral tape motion disturbance that can be cancelled out, it would be desirable to have an actuator for which resonances above the fundamental resonance are as high as possible.

### SUMMARY OF THE INVENTION

In general, in a first aspect, the invention features a tape head positioner including a tape head for accessing data stored on a magnetic tape, and a planar coil spaced apart from the tape head, wherein a major surface of the coil is operable to be positioned substantially parallel to a plane of the tape.

Embodiments of the invention may include one or more of the following features. An axis passing through the north and south magnetic poles of the coil may be substantially perpendicular to the plane of the tape. The center of mass of the positioner may be located at the intersection of two axes, where the two axes define a plane parallel to a major surface of the coil, and a third axis passes through the center of mass of the positioner, is perpendicular to the plane, and at least one point on the third axis is located at a distance of less than 0.3 inches from a center of force of the coil. The point on the third axis may pass through a center of force of the coil. The center of mass of the positioner may be positioned at a distance of less than 0.1 inches or 0.3 inches from a center of force of the coil.

The center of mass of the positioner may be positioned at substantially the same position as a center of force of the coil in two spatial dimensions, and at a distance of less than 0.1 inches from the center of force in a third spatial dimension. The center of mass of the positioner may be positioned at a distance of less than 0.3 inches from the center of force in the third spatial dimension.

The positioner may also include a first flexure positioned to a first side of the coil; and a second flexure positioned to a second side of the coil. The first and second flexures may extend substantially perpendicularly to a major surface of the coil. The first and second flexures may be parallel to an axis passing through the north and south magnetic poles of the coil. A major surface of the first flexure may be less than one inch in length and less than one inch in width. A major surface of the first flexure may be less than 0.8 inches in length and less than 0.75 inches in width. A major surface of the first flexure may be less than 0.6 inches in length and less than 0.55 inches in width. A major surface of the first flexure may be between 0.5 and 0.6 inches in length, and between 0.45 and 055 inches in width. At least one of the flexures may include a metal leaf spring.

At least one of the flexures may flex about a first axis parallel to a major surface of the flexure and may be stiff around a second axis perpendicular to the major surface. The first flexure may be flexible in a first plane and stiff in a second plane orthogonal to the first plane.

In general, in a second aspect, the invention features a tape head actuator, including a base; a tape head positioner including a tape head operable to access a tape; and a planar coil spaced apart from the tape head, wherein a major surface of the coil is operable to be positioned substantially parallel to a plane of the tape; a magnet holder attached to the base, the magnet holder having two spaced-apart side members, wherein the coil is positioned between the side members; a magnet attached to the magnet holder, wherein the magnet and magnet holder are operable to provide a magnetic field substantially perpendicular to the surface of the coil; a first flexure positioned to a first side of the coil, having a proximal end attached to the base and a distal end attached to the positioner; and a second flexure positioned to a second side of the coil, having a proximal end attached to the base and a distal end attached to the positioner. The magnet holder may include a ferrous material. The base may comprise a coarse positioner body. The magnet may be attached to an inner surface of the magnet holder. The center of mass of the actuator may be located at the intersection of two axes, where the two axes define a plane parallel to a major surface of the coil, and a third axis passes through the center of mass of the positioner, is perpendicular to the plane, and passes through a center of force of the coil. The center of mass of the positioner may be positioned at a distance of less than 0.1 or less than 0.3 inches from a center of force of the coil. The center of mass of the actuator may be positioned at substantially the same position as a center of force of the coil in two spatial dimensions, and at a distance of less than 0.1 inches from the center of force in a third spatial dimension. The center of mass of the actuator may be positioned at a distance of less than 0.3 inches from the center of force in the third spatial dimension.

The first and second flexures may extend substantially perpendicularly to a major surface of the coil. The actuator may include a position sensor operable to sense the position of the head. In a third aspect, the invention features a tape drive including the actuator.

### BRIEF DESCRIPTION

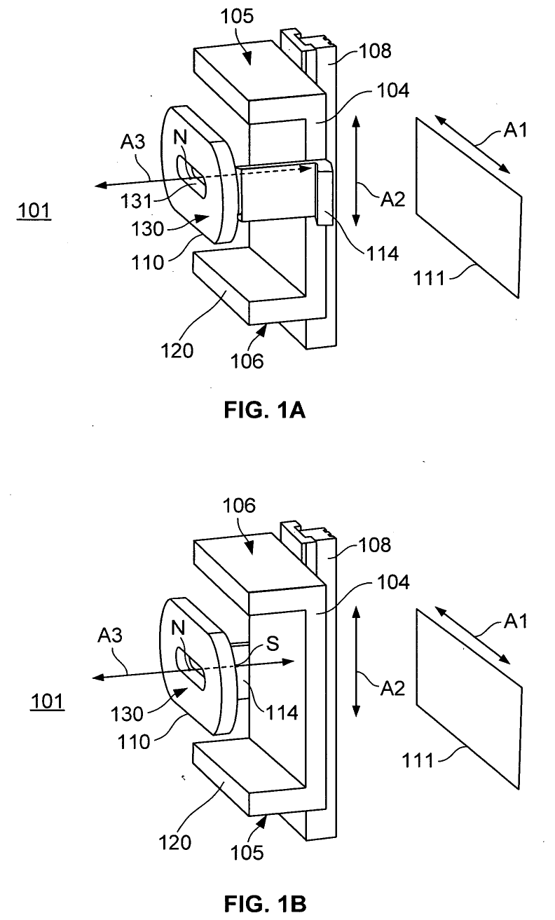

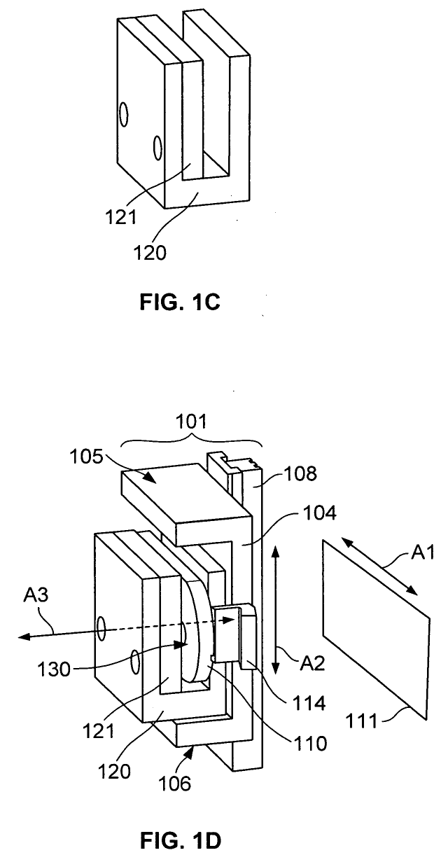

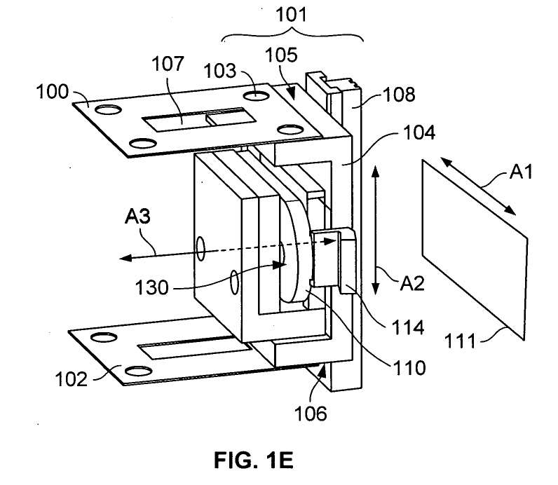

FIG. 1A is a front perspective view of a fine positioner of a tape head actuator according to one embodiment of the invention.

FIG. 1B is a rear perspective view of a fine positioner of a tape head actuator according to one embodiment of the invention.

FIG. 1C is a perspective view of a magnet holder and a magnet according to one embodiment of the invention.

FIG. 1D is a perspective view of a fine positioner positioned adjacent to a magnet holder and to a magnet according to one embodiment of the invention.

FIG. 1E is a perspective view of a fine positioner with attached flexures according to one embodiment of the invention.

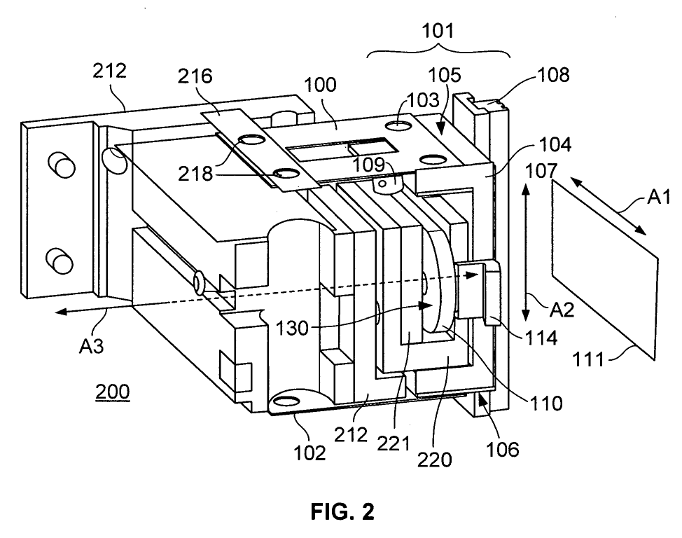

FIG. 2 is a perspective view of a tape head actuator according to one embodiment of the invention.

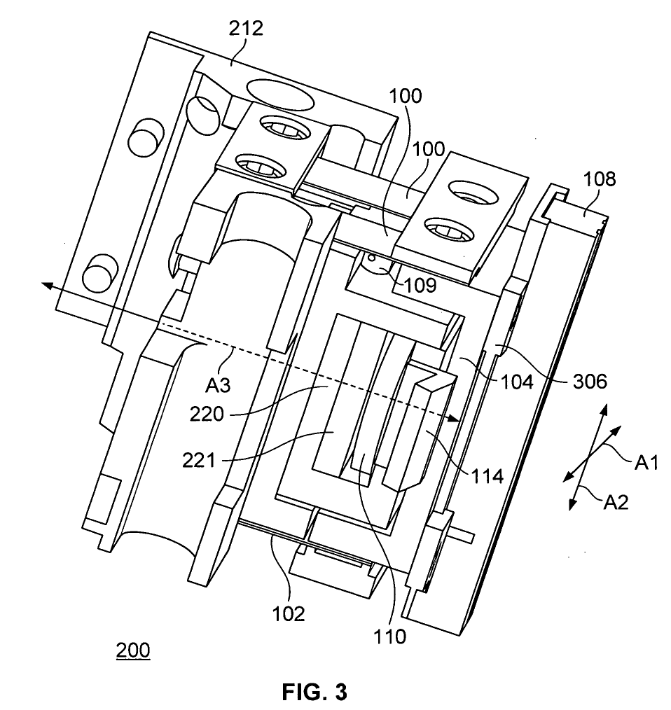

FIG. 3 is a side perspective view of a tape head actuator according to one embodiment of the invention.

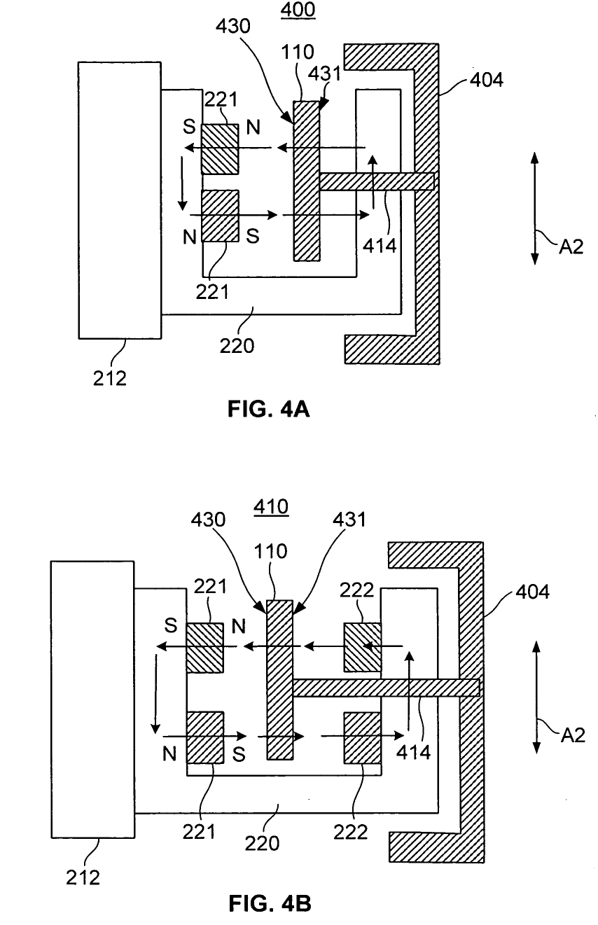

FIGS. 4A and 4B are side views of a fine positioner motor according to one embodiment of the invention.

### DETAILED DESCRIPTION

The following description is presented to enable any person skilled in the art to make and use the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

FIG. 1A is a front perspective view of a fine positioner 101 of a tape head actuator according to one embodiment of the invention. The fine positioner 101 is configured for use as part of a tape head actuator in a tape drive (not shown). The fine positioner 101 includes a tape head 108 and a planar magnetic positioning coil 110. The tape head 108 and the coil 110 are attached to a head mounting frame 104. The coil 110 is held at a distance from the head 108 by a strut 114 attached to the coil 110 and to the frame 104. The size of the strut 114 shown in FIG. 1 is exaggerated, particularly along an axis A3, to illustrate the distance between the coil 110 and the frame 104. As an alternative to the strut 114, the coil 110 could be held at a distance from the head 104 by, for example, an outward-extending portion of the frame 104.

The tape head 108 may read and write data on a tape 111. The tape head is, for example, a magnetic transducer, and the tape 111 is, for example, a magnetic data storage tape. The tape head 108 can move along an axis A2 to access multiple horizontal tracks on the tape 111.

The coil 110 is, for example, an insulated conductive wire, e.g., a copper wire, wrapped in a spiral shape to form a multi-turn, flat, rectangular coil with two rounded sides, two flat sides, and a major surface 130, which is in a plane defined by the axes A1 and A2. The dimensions of an example coil 110 are as follows. The upper and lower flat surfaces of the coil 110 are 0.413 inches in length (i.e., along axis A1). The outer radius of each rounded side of the coil is 0.157 inches. The width of the coil is 0.314 inches (along axis A2) and the overall length of the coil is 0.728 inches (along axis A1; the sum of 0.413, 0.157, and 0.157). The thickness of the coil is 0.049 inches (along axis A3). The coil 110 includes a slot 131, which is an empty area that has an inside surface around which internal windings (not shown) of the coil may be wound. The width of the slot 131 is 0.079 inches (along axis A2). Other examples of the coil 110 may have different dimensions.

FIG. 1B is a rear perspective view of a fine positioner 101 of a tape head actuator according to one embodiment of the invention. The coil 110 has magnetic poles at either end, near the major surface 130. When electric current flows through the coil 110, a north magnetic pole N is present at one end of the coil 110, and a south magnetic pole S is present at the other end of, i.e., on the reverse side of, the coil 110. The north pole S is positioned in front of the coil 110 in FIG. 1B and is shown as a dot for illustrative purposes. The south magnetic pole S is positioned behind the coil 110 in FIG. 1B and is shown as a dot for illustrative purposes. The axis A3 passes through a north pole N and a south pole S. The north pole N is located near the center of the major surface 130, for example. The south pole N is located near an opposite major surface (not shown), which is on the reverse, i.e., not shown, side of the coil 110. The locations of the north pole N and south pole S are determined by windings (not shown) in the coil 110 and the properties of the windings when electric current passes through the windings, as is known to those skilled in the art.

The axis A3 is perpendicular to a plane of the tape 111. The axes A1 and A2 are parallel to the plane of the tape. The major surface 130 of the coil is parallel to a plane of the tape 111. The plane of the tape, as known to those skilled in the art, is the plane occupied by a major surface of the tape 111 when the tape 111 is read or written by the head 108. The plane of the tape is substantially the plane defined by the axes A1 and A2.

The coil 110 is positioned near the head 108, so that the center of force of the coil 110 is positioned at substantially the same location as the center of mass of the fine positioner 101, or at a relatively small distance from the center of mass of the fine positioner 101. The small distance may, for example, allow for structural members between the coil 110 and the head 108. The term “aligned” is used herein to indicate that the center of force of the coil 110 is positioned relative to the center of mass of the fine positioner 101 within a predetermined distance and at a predetermined three-dimensional offset. The center of mass is a close approximation to the actual center of mass of the fine positioner 101, because the parts of the positioner 101 have tolerances which may cause the exact center of mass to be different from the nominal center by some small amount

In one aspect, the center of force of the coil 110 is at the same location as the center of mass of the fine positioner 101 in two of the three spatial dimensions, i.e., at zero offset, and the centers are separated by a small distance, e.g., 0.3 inches, in the third dimension. In another aspect, the center of force of the coil 110 is at a predetermined spatial offset from the center of mass of the fine positioner 101, e.g., at an offset of 0.3 inches in a first dimension, an offset of 0.01 inches in a second dimension, and an offset of 0.01 inches in a third dimension.

To achieve a small distance between the center of mass and the center of force, any structural members between the centers should be as thin or narrow as possible. If structural members are present, the coil 110 and the head 108 should be adjacent to opposite sides of the structural members. For example, the coil 110 is adjacent to an inner surface of the head mounting frame 104, and the head 108 is adjacent to an outer surface of the frame 104. The coil 110 is positioned as closely as possible to the center of mass of the head 108, with an allowance for the frame 104. Alternatively, the coil 110 could be positioned directly adjacent to the head 108. Placing the coil 110 as close as possible to the center of mass of the fine positioner 110 allows the fine positioner 110 to be small and light, and leads to small torques about the center of mass of the fine positioner 101, which raises resonant frequencies of the fine positioner 101.

FIG. 1C is a perspective view of a magnet holder 120 and a magnet 121 according to one embodiment of the invention. The magnet holder 120 wraps partially or fully around the magnet 121, and the magnet 121 is mounted on the magnet holder 120. The magnet holder 120 is of a ferromagnetic material, e.g., steel or the like. The magnet 121 may be, for example, a two-pole magnet or a four-pole magnet, as described in more detail below.

FIG. 1D is a perspective view of a fine positioner 101 positioned adjacent to a magnet holder 120 and to a magnet 121 according to one embodiment of the invention. The magnet 121 is positioned adjacent to the major surface 130 of the coil 110, so that the magnet holder 121 wraps partially or fully around the coil 110. The fine positioner 101 moves relative to the magnet holder 120 and to the magnet 121. In one aspect, the fine positioner 101 is not attached to the magnet holder 120 or the magnet 121. That is, neither the coil 110, the strut 114, nor the frame 104 is attached to the magnet holder 120 or to the magnet 121. If the fine positioner 101 were to be attached to the magnet holder 120 or magnet 121, then the attachment should allow the fine positioner 101 to move relative to the magnet holder 120 and the magnet 121. An electric current may be applied to the coil 110 to move the fine positioner 101, as described below.

FIG. 1E is a perspective view of a fine positioner 101 with attached flexures according to one embodiment of the invention. An upper flexure 100 and a lower flexure 102 are attached to the head mounting frame 104 and are positioned on opposite sides of the coil 110. Each flexure is flexible in one plane and stiff in other planes. The plane in which a flexure is flexible is referred to herein as a plane of flexion. A flexure may be, for example, a rectangular sheet of thin metal. The major surfaces of the flexure or sheet correspond to the flexure's plane of flexion. The flexures allow the fine positioner 101 to move freely, and without hysteresis, by a limited distance along an axis A2 in a direction transverse to a tape 111 and substantially perpendicular to the flexures' planes of flexion. Since the flexures are relatively stiff in other directions, the fine positioner 101 does not move substantially in the directions of axes A1 and A3. The flexures 100, 102 may be of any type of flexible material with elastic properties, such as a flat spring or flat members connected by a spring-loaded hinge. In one aspect, each of the flexures 100, 102 includes a void, such as a rectangular hole in the center of the flat surface of the flexure. In one aspect, each flexure 100, 102 has a rectangular void 107, which divides the flexure 100, 102 into two longitudinal bar regions. Each rectangular flexure 100, 102 is, for example, 0.512 inches in width (i.e., along axis A1) by 0.551 inches in length (along axis A3) by 0.003 inches in thickness (along axis A2). The thickness of each flexure 100, 102 may be between 0.002 inches and 0.005 inches (along axis A2). Other examples of the flexures 100, 102 may have different dimensions. The upper flexure 100 need not have the same dimensions as the lower flexure 102.

The head 108 may read and write data stored on the tape 11. The tape 111 moves past the head 108 in a direction parallel to an axis A1. The coil 110 is positioned between the flexures 100, 102 to allow for rigid coupling of the coil 110 to the head 108 by the strut 114. This arrangement improves resonance performance by raising the resonant frequencies of the fine positioner 101, and also reduces the size of and mass of the fine positioner 101. Decreasing the mass of the fine positioner 101 allows for higher-frequency operation. The high out-of-plane stiffness of the flexures allows the head positioning system to follow lateral motion of the tape 111 in the direction of the axis A2 while not generating out-of-plane motions caused by natural resonances in frequency ranges which can influence the tracking system. The flexures 100, 102 have a length, sometimes referred to herein as an active length, which is the longitudinal length of the flexure 100 along an axis A3. The flexures 100, 102 also have a width along the plane A1.

The distal end of the upper flexure 100 is attached to a top side 105 of the head frame 104 and extends substantially perpendicularly from the head frame 104. The upper flexure 100 is substantially parallel to the top side 105. The distal end of the lower flexure 102 is attached to a bottom side 106 of the head frame 104, and the lower flexure 102 extends substantially perpendicularly from the head frame 104. The lower flexure 102 is substantially parallel to the bottom side 106. The flexures are substantially perpendicular to the major surface 130 of the coil 110. The flexures 100, 102 may be, for example, metal leaf springs.

The flexures 100, 102 are substantially parallel to the axis A3 passing through the magnetic poles of the coil 110 when current is applied to the coil 110, i.e., through the north pole N and the south pole S of the coil 110 shown in FIG. 1B.

The term “substantially” is used herein to indicate an approximation of a perpendicular or parallel orientation, e.g., at a perpendicular or parallel orientation plus or minus 5 degrees in either or both directions. The coil 130 is substantially parallel to the plane of the tape 111 defined by the axes A1 and A2. The term “substantially” indicates that the coil 130 may be oriented parallel to, i.e., at an angle of 0 degrees to, the plane of the tape 111, or at an angle of up to plus or minus 5 degrees to the axis A1 or to the axis A2, or at up to plus or minus 5 degrees of each axis A1, A2. The 0 degree angle is shown in the figures and is used here for illustrative purposes. To illustrate the term “substantially perpendicular”, the upper flexure 100 may be perpendicular, i.e., at a 90 degree angle, to the head frame 104, or may be at some other angle within approximately 5 degrees of a right angle, e.g., 85 degrees. The 90 degree angle is shown in the figures and is used for illustrative purposes. However, the flexures may be at others angles to the head frame. Angles other than 90 degrees may cause the flexures to impart a tip of the head 108 into and out of the plane of the tape 111 as the head 108 moves along the axis A2. Therefore, the angle is typically 90 degrees, or close to 90 degrees, e.g., 85 or 95 degrees.

An electric current may be applied to the coil 110 to move the fine positioner 101 along the axis A2. The flow of electric current through the coil 110, which is in the magnetic field created by the magnets 221, generates a force which moves the coil 110 and consequently the fine positioner 101, including the head 108, in a direction parallel to the axis A2. The direction of the current flow determines the direction of the generated force, and therefore the direction of movement of the fine positioner 101 along the axis A2.

FIG. 2 is a perspective view of a tape head actuator 200 according to one embodiment of the invention. The actuator 200 is configured for use in a tape drive (not shown). The tape head actuator 200 includes the fine positioner 101 attached to a base 212 by flexures 100, 102. The base 212 may be, for example, a coarse positioner body, which moves relative to another object, such as a tape drive. A proximal end of each flexure 100, 102 is attached to the base 212, and a distal end of each flexure 100, 102 is attached to a head mounting frame 104 of the fine positioner 101. The base 212 moves parallel to the axis A2, transverse to the length of the tape 111, to read and write data on longitudinal tracks of the tape 111. The base 212 includes a magnet holder 220 and magnet 221, which produce a magnetic field at right angles to the coil 110 to precisely move the head 108 by relatively small distances along the transverse axis A2. The flexures 100, 102 allow the head 108 to move freely parallel to the transverse axis A2 without hysteresis. The flexures 100, 102 hold the fine positioner, which includes the head 108, in a substantially fixed position in other directions, relative to the base 112.

The position of the coil 110 between the flexures 100, 102 and in close proximity to the head 108 allows the actuator servo control system to operate at high frequencies, e.g., above 800 Hz, because the center of force produced by the coil is located as close as possible to the center of mass of the fine positioner 101, and that arrangement reduces the torques on the fine positioner 101. The relative stiffness of the flexures 100, 102 in the axes normal to the axis A2 also contributes to the ability of the actuator to operate at high frequencies. In one aspect, the coil 110 and the head 108 are mounted on the frame 104 so that the center of force of the coil 110 is located as close as possible to the center of mass of the fine positioner 101. The mounting attachment may be secured by screws or other fasteners, and may include plates, e.g., a plate 216, to hold the flexures against the frame 104. Alternatively, some or all of the components, including the coil 110, the head 108, and the flexures 100, 102 may be integrally formed in a single assembly.

The coil 110 is positioned on the head frame 104 between the upper flexure 100 and the lower flexure 102, and the plane of the flat side of the coil 110 is substantially perpendicular to the upper flexure 100 and the lower flexure 102. That is, the flat side of the coil 110 is typically at a 90 degree angle to the flexures, but other orientations are possible. In one aspect, the coil 110 is attached to an inner side of the head mounting frame 104.

In one example, the flexures may extend at non-right angles from the coil, or the coil may be positioned at a slightly non-right angle. A base 212 is spaced apart from the head frame 104, and the upper flexure 100 and the lower flexure 102 are affixed to the base 212, e.g., by screws 218 which secure the mounting plate 216 against the upper flexure 100. In another example, the upper flexure 100 and the lower flexure 102 may be integrally formed upon the head frame 104. The flexures 100, 102 allow motion of the head frame 104 in a direction substantially perpendicular to the flexures 100, but restrict motion of the head frame 104 in other directions.

The actuator 200 also includes a tape head 108 attached to the head mounting frame 105. The tape head 108 can read and write data stored on the tape 111, wherein the tape 111 moves parallel to an axis A1. The tape 111 is adjacent to the tape head 108 and substantially parallel to the coil 110. That is, the tape 111 may be parallel to the coil 110, or at a slight angle to the coil, e.g., 15 degrees.

At least one of the flexures 100, 102 may be attached to the base 212 at two locations, e.g., at screws 218. At least one of the flexures 100, 102 may be secured to the base 212 by a plate 216, and the plate 216 may be secured to the body 212 by at least one screw 218. Similarly, at least one of the flexures 100, 102 may be attached to the head mounting frame 104 at two locations, e.g., at screws 103. At least one of the flexures 100, 102 may be secured to the head mounting frame 104 by a plate (not shown, but similar to the plate 216), and the plate (not shown) may be secured to the frame 104 by at least one screw 103.

A position sensor 109 may be mounted on the base 212 to monitor the position of the head frame 105 with respect to the base 212. Position information from the position sensor 109 is used to maintain the position of the head 108 during shock events. The position sensor 109 may be, for example, an optical interrupter, a miniature Hall-effect sensor, and inductive sensor, or the like. During a mechanical shock event the head 108 and frame 104 may move before the servo system can detect that the head 108 is moving off track. The sensor 109 provides immediate feedback which can be used to correct the position of the head 108, e.g., by generating appropriate current in the coil 110 to move the frame 104 to position the head 108 on the correct tape track.

FIG. 3 is a side perspective view of a tape head actuator 200 according to one embodiment of the invention. The tape head 108 is attached to an intermediate head adapter 306, which is in turn attached to the head mounting frame 104.

FIG. 4A is a side view of a fine positioner motor 400 according to one embodiment of the invention. The fine positioner motor 400 forms a magnetic circuit. The motor 400 includes two magnets 221 attached to an inner surface of a magnet holder 220. The motor 400 is attached to a base 212. A coil 110 is attached to the fine positioner and mounted in the magnet holder 220 and positioned next to the magnets 221.

The magnet 221 may be, for example, a single-pole magnet, in which case two magnets 221 are used, as shown in FIG. 4A. The magnet 221 may alternatively be a single two-pole magnet, as described in more detail below. In either case the magnetic field represented by the arrows shown in FIG. 4A is created. The choice of a single-pole or two-pole magnet is determined by manufacturing or commercial considerations

The magnet 221 is configured to provide a magnetic field in a direction substantially perpendicular to a major surface 430, 431 of the coil 110. The magnetic field is shown in FIG. 4A as arrows directed through the poles of the magnet 221. When current flows through the coil 110, the resulting force cause the frame 104 and the attached tape head 108 to move along an axis A2 transverse to the length of the tape 111.

FIG. 4B is a side view of a fine positioner motor 410 according to one embodiment of the invention. The fine positioner motor 410 forms a magnetic circuit and is similar to the motor 400 of FIG. 4A. The motor 410 includes additional magnets 221 which increase the force that the motor exerts on the coil 110. The motor 410 includes two magnets 221 attached to an inner surface of the magnet holder 220, and two magnets 222 attached to another inner surface of the magnet holder 220 on an opposite side of the coil 110 from the magnets 220. The motor 410 is attached to a base 212. A coil 110 is attached to the fine positioner and mounted in the magnet holder 220 and positioned between the magnets 221.

Each magnet 221, 222 has a north pole and a south pole. The magnets 221, 222 are configured to provide a magnetic field in a direction substantially perpendicular to a major surface 430, 431 of the coil 110. The magnetic field is shown in FIG. 4B as arrows directed through the poles of the magnets 221, 222. When current flows through the coil 110, the resulting force causes the frame 104 and the attached tape head 108 to move along an axis A2 transverse to the length of the tape 111.

The actuator disclosed herein has significantly higher resonant frequencies than existing actuators because the position of the planar coil in close proximity to the read/write head, the orientation of the coil parallel to the tape, and the position of the flexures above and below the coil and the high out-of-plane stiffness of the flexures. Because of its high resonant frequencies, the actuator can be operated with a high-bandwidth servo control system, and therefore can provide increased tracking precision and greater data storage capacities.

This disclosure is illustrative and not limiting; further modifications will be apparent to those skilled in the art in light of this disclosure and are intended to fall within the scope of the appended claims.

What is claimed is:

1. A tape head positioner comprising:
a tape head for accessing data stored on a magnetic tape; and
a planar coil spaced apart from the tape head,
wherein a major surface of the coil is operable to be positioned substantially parallel to a plane of the tape.

2. The positioner of claim 1, wherein an axis passing through the north and south magnetic poles of the coil is substantially perpendicular to the plane of the tape.

3. The positioner of claim 1, wherein the center of mass of the positioner is located at the intersection of two axes, the two axes define a plane parallel to a major surface of the coil, and a third axis passes through the center of mass of the positioner, is perpendicular to the plane, and at least one point on the third axis is located at a distance of less than 0.3 inches from a center of force of the coil.

4. The positioner of claim 1, wherein the center of mass of the positioner is located at the intersection of two axes, the two axes define a plane parallel to a major surface of the coil, and a third axis passes through the center of mass of the positioner, is perpendicular to the plane, and passes through a center of force of the coil.

5. The positioner of claim 1, wherein the center of mass of the positioner is positioned at a distance of less than 0.1 inches from a center of force of the coil.

6. The positioner of claim 1, wherein the center of mass of the positioner is positioned at a distance of less than 0.3 inches from a center of force of the coil.

7. The positioner of claim 1, wherein the center of mass of the positioner is positioned at substantially the same position as a center of force of the coil in two spatial dimensions, and at a distance of less than 0.1 inches from the center of force in a third spatial dimension.

8. The positioner of claim 7, wherein the center of mass of the positioner is positioned at a distance of less than 0.3 inches from the center of force in the third spatial dimension.

9. The positioner of claim 1, further comprising:
a first flexure positioned to a first side of the coil; and
a second flexure positioned to a second side of the coil.

10. The positioner of claim 9, wherein the first and second flexures extend substantially perpendicularly to a major surface of the coil.

11. The positioner of claim 9, wherein the first and second flexures are parallel to an axis passing through the north and south magnetic poles of the coil.

12. The positioner of claim 9, wherein a major surface of the first flexure is less than one inch in length and less than one inch in width.

13. The positioner of claim 9, wherein a major surface of the first flexure is less than 0.8 inches in length and less than 0.75 inches in width.

14. The positioner of claim 9, wherein a major surface of the first flexure is less than 0.6 inches in length and less than 0.55 inches in width.

15. The positioner of claim 9, wherein a major surface of the first flexure is between 0.5 and 0.6 inches in length, and between 0.45 and 055 inches in width.

16. The positioner of claim 9, wherein at least one of the flexures comprises a metal leaf spring.

17. The positioner of claim 9, wherein at least one of the flexures is operable to flex about a first axis parallel to a major surface of the flexure and to be stiff around a second axis perpendicular to the major surface.

18. The apparatus of claim 9, wherein the first flexure is flexible in a first plane and stiff in a second plane orthogonal to the first plane.

19. A tape head actuator, comprising:
a base;
a tape head positioner including
a tape head operable to access a tape; and
a planar coil spaced apart from the tape head,
wherein a major surface of the coil is operable to be positioned substantially parallel to a plane of the tape;
a magnet holder attached to the base, the magnet holder having two spaced-apart side members, wherein the coil is positioned between the side members;
a magnet attached to the magnet holder, wherein the magnet and magnet holder are operable to provide a magnetic field substantially perpendicular to the surface of the coil;
a first flexure positioned to a first side of the coil, having a proximal end attached to the base and a distal end attached to the positioner; and
a second flexure positioned to a second side of the coil, having a proximal end attached to the base and a distal end attached to the positioner.

20. The positioner of claim 19, wherein the magnet holder comprises a ferrous material.

21. The actuator of claim 19, wherein the base comprises a coarse positioner body.

22. The actuator of claim 19, wherein the magnet is attached to an inner surface of the magnet holder.

23. The actuator of claim 19, wherein the center of mass of the actuator is located at the intersection of two axes, the two axes define a plane parallel to a major surface of the coil, and a third axis passes through the center of mass of the positioner, is perpendicular to the plane, and passes through a center of force of the coil.

24. The actuator of claim 19, wherein the center of mass of the positioner is positioned at a distance of less than 0.1 inches from a center of force of the coil.

25. The actuator of claim 19, wherein the center of mass of the positioner is positioned at a distance of less than 0.3 inches from a center of force of the coil.

26. The actuator of claim 19, wherein the center of mass of the actuator is positioned at substantially the same position as a center of force of the coil in two spatial dimensions, and at a distance of less than 0.1 inches from the center of force in a third spatial dimension.

27. The actuator of claim 19, wherein the center of mass of the actuator is positioned at a distance of less than 0.3 inches from the center of force in the third spatial dimension.

28. The actuator of claim 19, wherein the first and second flexures extend substantially perpendicularly to a major surface of the coil.

29. The actuator of claim 19, wherein a major surface of the first flexure is less than one inch in length and less than one inch in width.

30. The actuator of claim 19, wherein a major surface of the first flexure is less than 0.8 inches in length and less than 0.75 inches in width.

31. The actuator of claim 19, wherein a major surface of the first flexure is less than 0.6 inches in length and less than 0.55 inches in width.

32. The actuator of claim 19, wherein a major surface of the first flexure is less between 0.5 and 0.6 inches in length, and between 0.45 and 055 inches in width.

33. The actuator of claim 19, wherein at least one of the flexures comprises a metal leaf spring.

34. The actuator of claim 19, wherein at least one of the flexures is operable to flex about a first axis parallel to a major surface of the flexure and to be stiff around a second axis perpendicular to the major surface.

35. The actuator of claim 19, wherein the first flexure is flexible in a first plane and stiff in a second plane orthogonal to the first plane.

36. The actuator of claim 19, further comprising a position sensor operable to sense the position of the head.

37. A tape drive comprising the actuator of claim 19.
